(19) United States
(12) Patent Application Publication
(10) Pub. No.: US 2024/0387845 A1
(43) Pub. Date: Nov. 21, 2024

(54) INTEGRATED FUEL CELL SYSTEM WITH CATHODE EXHAUST-DRIVEN REFORMING PROCESS AND METHOD OF OPERATION

(71) Applicant: FALCON FUEL CELLS INC., Pittsford, NY (US)

(72) Inventors: Michael Waller, Pittsford, NY (US); Steven Goebel, Victor, NY (US)

(21) Appl. No.: 18/665,075

(22) Filed: May 15, 2024

Related U.S. Application Data
(60) Provisional application No. 63/502,275, filed on May 15, 2023.

(51) Int. Cl. H01M 8/0612; C01B 3/12; F28F 13/06; H01M 8/04007; H01M 8/04014; H01M 8/04029; H01M 8/04111; H01M 8/04302; H01M 8/04303; H01M 8/2457

(52) U.S. Cl. CPC H01M 8/0631; C01B 3/12; F28F 13/06; H01M 8/04014; H01M 8/04029; H01M 8/04074; H01M 8/04111; H01M 8/04302; H01M 8/04303; H01M 8/2457; C01B 2203/0283; C01B 2203/067; C01B 2203/0883

(57) ABSTRACT

The disclosure relates to an integrated fuel cell system designed to enhance operational efficiency and reduce complexity. The system incorporates a high-temperature proton exchange membrane (HT-PEM) fuel cell coupled with a novel reformer that utilizes cathode exhaust from the fuel cell. This exhaust provides both oxidant and water vapor necessary for the reforming process, thereby eliminating the need for separate humidification and simplifying the gas purification steps typically required to remove carbon monoxide. The reformer is capable of operating under conditions of catalytic partial oxidation (cPOx), autothermal reforming (ATR), and water gas shift (WGS) reactions. This integration facilitates a more compact design, reduces the weight of the system, and enhances overall efficiency by effectively managing heat and reducing carbon monoxide levels in the hydrogen feed. The system is particularly suited for mobile applications where space and weight are critical constraints.

### CROSS-REFERENCE TO RELATED APPLICATIONS

This application claims the benefit of U.S. Provisional Application No. 63/502,275, filed on May 15, 2023. The entire disclosure of the above application is incorporated herein by reference.

### FIELD

The present technology relates to fuel cell systems and, more particularly, to methods and systems for improving efficiency and reducing complexity in fuel cell operations through integrated reforming processes utilizing cathode exhaust.

### INTRODUCTION

This section provides background information related to the present disclosure which is not necessarily prior art.

Fuel cells are a promising technology for generating clean energy, but face several challenges that limit wider adoption and effectiveness. Low-temperature proton exchange membrane (LT-PEM) fuel cells, while beneficial for certain applications, require extensive infrastructure for hydrogen storage. These systems often involve large, heavy tanks to store hydrogen gas at high pressures, which can be impractical for mobile applications and add significant weight and complexity to the system.

Another issue with LT-PEM fuel cells is a low operating temperature, which necessitates complex systems for moisture management to maintain membrane conductivity. These systems must carefully balance humidity to ensure efficient operation, which can complicate system design and reduce overall reliability. Additionally, the low operating temperature can limit the ability of these fuel cells to efficiently remove waste heat, further complicating integration into vehicle systems where thermal management can be important.

High-temperature proton exchange membrane (HT-PEM) fuel cells offer a solution to some of these issues, operating at higher temperatures that allow for simpler heat management and reduced reliance on external humidification. However, HT-PEM fuel cell systems can require a source of hydrogen that is free from carbon monoxide (CO), as even small amounts of CO can poison the fuel cell catalyst. This can necessitate the use of complex and costly gas purification systems to remove CO from the hydrogen feed, which can negate some of the benefits of moving to higher operating temperatures.

The integration of fuel reformers with HT-PEM fuel cells, while potentially reducing the need for pure hydrogen storage, also introduces its own set of challenges. These systems must effectively manage the reformate gas, which contains a mixture of hydrogen, carbon monoxide, and other gases. Managing these gases to prevent catalyst poisoning while maintaining efficient operation of the fuel cell requires sophisticated control systems and can present issues in optimizing performance.

There is a continuing need for more efficient and simpler fuel cell systems that can overcome the limitations of current technologies. Desirably, such systems would minimize or eliminate the need for large onboard hydrogen storage, complex humidity control, and extensive gas purification while maintaining high efficiency and operational reliability, and also would make fuel cells more practical for a wider range of applications, including mobile and portable devices.

### SUMMARY

In concordance with the instant disclosure, more efficient and simpler fuel cell systems and methods that can overcome the limitations of current technologies which minimize or eliminate the need for large onboard hydrogen storage, complex humidity control, and extensive gas purification while maintaining high efficiency and operational reliability, and which make fuel cells more practical for a wider range of applications, including mobile and portable devices, have surprisingly been discovered.

The present technology includes articles of manufacture, systems, and processes that relate to the integration of high-temperature proton exchange membrane (HT-PEM) fuel cells with advanced reforming techniques that utilize cathode exhaust for improved efficiency and reduced system complexity.

In certain embodiments, a fuel cell system includes a fuel cell stack. An integrated reformer can be configured to receive cathode exhaust from the fuel cell stack. A first heat exchanger, in communication with the integrated reformer, can be positioned to heat the cathode exhaust from the reformer. A water gas shift reactor, in communication with the first heat exchanger, can be configured to perform a reaction of carbon monoxide with water to form carbon dioxide and hydrogen. A second heat exchanger, in communication with the water gas shift reactor, can be configured to control a temperature of reformate entering the fuel cell stack. A third heat exchanger, in communication with the second heat exchanger, can be configured to maintain a temperature of a coolant loop. The fuel cell system is operable in a first mode with cathode exhaust preheating and coolant for water gas shift temperature reactor temperature control, and a second mode without cathode exhaust preheating and with heat removal directly to ambient for water gas shift reactor temperature control. The first mode can include operating the first heat exchanger with preheated cathode exhaust and utilizing a coolant in the water gas shift temperature reactor control, and the second mode can include bypassing the preheating of the cathode exhaust and utilizing air cooling for heat removal in the water gas shift temperature reactor temperature control.

In certain embodiments, a method of operating a fuel cell system includes providing the fuel cell system and selectively operating the fuel cell system in a first mode wherein the cathode exhaust is preheated, and a coolant is utilized for water gas shift temperature reactor temperature control, or in a second mode wherein preheating of the cathode exhaust is bypassed and air cooling is utilized for heat removal in the water gas shift temperature reactor temperature control.

In certain embodiments, the present technology relates to a HT-PEM fuel cell. In particular, the HT-PEM fuel cell can recirculate cathode exhaust to an integrated reformer. The cathode exhaust from a HT-PEM fuel cell stack can be directed into the integrated reformer to provide oxidant and water vapor. A hydrocarbon can be used as the fuel; e.g., propane. The HT-PEM fuel cell can operate at 120-200° C. The integrated reformer can include a combination of one or more reactors operating under catalytic partial oxidation (cPOx), autothermal reforming (ATR), and/or water gas shift (WGS) conditions.

The cathode exhaust can be heated within a heat exchanger (HX1) after the reformer to improve fuel cell system efficiency or may not be preheated. The temperature into the water gas shift reactor and HT-PEM can be controlled with either heat exchange to a coolant or heat removal directly to ambient with air cooling. Heaters can be used to bring the ATR reactor and fuel cell stack to temperature to begin operation. A valve on the fuel supply can be used to turn the fuel cell system on and off. A pump in the coolant loop can be used to drive the coolant flow and fans are used to remove heat from heat exchangers. A compressor can be used to supply the fuel cell system air flow to the fuel cell stack and then as cathode exhaust to the reformer.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a flow chart depicting a fuel cell system in a first mode according to one embodiment of the present disclosure;

FIG. 2 is a flow chart depicting a fuel cell system in a second mode according to one embodiment of the present disclosure; and

FIG. 3 is a flow chart depicting a method of operating the fuel cell system according to a further embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology improves the efficiency and portability of fuel cell systems by eliminating the need for condenser and vaporizer components, which can add significant weight and complexity. By utilizing the cathode exhaust from a high temperature proton exchange membrane (HT-PEM) fuel cell, which includes both oxidant and water vapor, the fuel cell system directly feeds these components into the integrated reformer. This approach not only simplifies the overall design but also enhances the operational efficiency of the fuel cell system. The water vapor present in the cathode exhaust facilitates the water gas shift reaction within the reformer, increasing hydrogen production while simultaneously reducing carbon monoxide levels. As a result, the fuel cell system can achieve a higher performance with reduced mass and complexity, making it particularly advantageous for mobile applications where space and weight are important considerations.

The fuel cell system can include a fuel cell stack, an integrated reformer, one or more heat exchangers, a water gas shift (WGS) reactor, and a compressor, among other components. The fuel cell system can be operated in two distinct modes, each suited to different external conditions and operational requirements. The first mode can include preheating the cathode exhaust and utilizing a coolant for temperature control in the water gas shift reactor. The first mode can be particularly advantageous in colder external temperatures where maintaining a higher operational temperature is necessary for efficient reaction kinetics and optimal fuel cell system performance. Additionally, the first mode can be beneficial when high thermal efficiency is required, as the controlled use of coolant helps manage the heat exchange effectively, optimizing the fuel cell system's overall efficiency.

The fuel cell system can be operated in a second mode that bypasses the preheating of the cathode exhaust and employs direct air cooling for heat removal in the water gas shift reactor. The second mode can be preferable in warmer external conditions where the ambient temperature supports natural cooling processes, thus reducing the necessity for preheating. The second mode can also simplify the fuel cell system operation by reducing the complexity associated with heat management, which can be particularly useful in environments that allow for passive cooling strategies, thereby conserving energy.

The ability of the fuel cell system to switch between the first mode and the second mode based on external temperature conditions can enhance its versatility and adaptability, ensuring that the fuel cell system remains efficient and stable under varying operational demands. This dual-mode operation can significantly contribute to the longevity and reliability of the fuel cell system, making it suitable for a wide range of applications and environmental conditions. Switching between the first mode and the second mode can also optimize operation during environmental changes throughout the day as well as seasonal changes.

The fuel cell system can include a fuel cell stack of multiple fuel cells, where the fuel cell stack provides for electrochemical conversion of fuel to electricity. The fuel cell stack can be specifically designed to accommodate high-temperature operations, enhancing efficiency and tolerance to various fuel impurities, such as carbon monoxide, which is often present in reformed fuels. The fuel cell stack can include a high-temperature proton exchange membrane (HT-PEM) and can operate effectively at temperatures between 120-200° C., which can allow for improved heat removal and durability of the membrane material.

An integrated reformer can be configured within the fuel cell system to receive cathode exhaust from the fuel cell stack. The integrated reformer can utilize the cathode exhaust, which contains unreacted oxygen and water vapor, to facilitate the reforming process where a hydrocarbon fuel from a fuel supply is converted into a hydrogen-rich gas, suitable for use as an anode feed in the fuel cell stack. The integrated reformer can include one or more reactors that operate under conditions such as catalytic partial oxidation (cPOx), autothermal reforming (ATR), and water gas shift (WGS), enhancing the conversion efficiency of the fuel to hydrogen. The integrated reformer can include a heating element. The heating element can be configured to heat the hydrocarbon fuel and reformate gas. This can be particularly beneficial during start-up conditions.

A first heat exchanger can be included and can be positioned in thermal communication with a cathode exhaust stream to heat the cathode exhaust coming from the fuel cell stack in the first mode. The first heat exchanger can enhance the efficiency of the reforming process by ensuring that the cathode exhaust gases are at an appropriate temperature for processing, thus improving the overall energy efficiency of the fuel cell system. The first heat exchanger can operate with the preheated cathode exhaust and utilize a coolant in the water gas shift temperature reactor control during the first mode of operation. The first heat exchanger can utilize either a cooling air flow, a cooling liquid flow, and combinations thereof to maintain the temperature entering the water gas shift reactor.

The fuel cell system can also include a water gas shift (WGS) reactor in thermal communication with the first heat exchanger and in fluid communication with the integrated reformer. The WGS reactor can convert carbon monoxide and water into carbon dioxide and additional hydrogen through the water-gas shift reaction, further increasing the hydrogen yield and reducing the carbon monoxide concentration before the reformate enters the fuel cell stack. The water gas shift reactor can facilitate managing the emissions and enhancing the purity of the hydrogen used in the fuel cell.

A second heat exchanger can be included and can be positioned in thermal communication with the reformate for controlling the temperature of the reformate entering the fuel cell stack as the anode feed. By adjusting the temperature of the incoming gases, the second heat exchanger can help maintain the operational stability of the fuel cell stack, allowing the fuel cell to operate within the preferred temperature range for improved efficiency. The second heat exchanger can utilize a fan system to maintain the preferred temperature of the reformate.

Additionally, a third heat exchanger can be positioned in thermal communication with the fuel cell stack, as well as other components of the fuel cell system. The third heat exchanger can be configured to maintain the temperature of a coolant loop in thermal communication with the fuel cell stack. The coolant loop can, for example, include cycling a coolant through portions of the fuel cell system to manage heat transfer to and from certain components. The third heat exchanger can facilitate managing the excess heat generated by the fuel cell system, thereby militating against overheating and potential damage to the fuel cell system components. The third heat exchanger can utilize a fixed flow rate cooling pump to manage the cooling requirements effectively.

In addition to the primary components discussed, the fuel cell system can incorporate several other critical elements as outlined in the dependent claims. These include the fuel supply, compressors, and fans as discussed in greater detail herein.

The fuel supply can provide a hydrocarbon fuel, such as propane, to the integrated reformer. Supply of the hydrocarbon fuel can be controlled by a valve system, which can regulate the flow of fuel based on the operational demands of the fuel cell system. This regulation allows the integrated reformer to receive an optimal amount of fuel for the reforming process, enhancing the production of hydrogen-rich reformate while maintaining fuel cell system efficiency and safety.

One or more compressors in the fuel cell system can serve multiple functions. A compressor can be configured to supply air to both the fuel cell stack and the integrated reformer. This dual supply role can ensure that the air flow rates are sufficient to support the electrochemical reactions in the fuel cell stack and the reforming reactions in the integrated reformer. The operation of the compressor can be controlled to adjust the air flow rates, to optimize the response of the fuel cell system to varying operational conditions and demands. The air flow required to achieve the desired outlet temperature of the integrated reformer can be controlled by the speed of the compressor. This allows for dynamic adjustments based on real-time performance data, with the integrated reformer outlet temperature serving as a feedback parameter. This feedback mechanism allows the reactor to operate within its optimal temperature range, enhancing the efficiency of the reforming process.

One or more fans within the fuel cell system can be configured to manage the thermal environment of the fuel cell system. For instance, a fan can be associated with one of the heat exchangers in order to control the temperature of the reformate entering the fuel cell stack and to maintain the temperature of the coolant loop. These fans can operate at speeds or duty cycles that are adjusted based on the thermal load, ensuring that the fuel cell system components operate within their temperature thresholds. This adjustment helps in militating against overheating and improves the longevity and performance of the fuel cell system.

The integration of the fuel supply, compressors, and fans into the fuel cell system can be managed by an operational control system. The operational control system can be configured to manage the operation of the fuel cell system, including startup, steady-state operation, and shutdown. The operational control system can adjust the cathode air flow rate to control the temperature of the integrated reformer based on the operational state of the fuel cell stack. Additionally, the operational control system can manage the fuel flow and air flow during startup and shutdown phases, ensuring that the transitions are smooth and do not adversely affect the performance of the fuel cell system.

The fuel cell system can manage the flow of certain fluids such as air, reformate, and coolant through the necessary components, allowing for optimal operation and energy conversion. Air, primarily utilized as an oxidant and a cooling agent within the fuel cell system, can be managed through a series of controlled processes. Initially, air can be drawn into the fuel cell system by a compressor, which can compress the air to a suitable pressure for the fuel cell reactions. This compressed air can then be directed into the fuel cell stack, where it participates in electrochemical reactions to generate electricity. The unreacted oxygen and water vapor, components of the cathode exhaust, can be subsequently directed into the integrated reformer. In the reformer, the cathode exhaust can serve dual purposes: it can act as an oxidant to aid in the conversion of hydrocarbon fuels to a hydrogen-rich reformate and can contribute to the water gas shift reaction, optimizing hydrogen yield and minimizing carbon monoxide content. The flow rate of air through the fuel cell system, particularly during the startup phase, can be controlled by adjusting the compressor speed based on the desired outlet temperature of the integrated reformer, thereby enhancing the efficiency and stability of the integrated reformer.

Reformate, the hydrogen-rich output from the reformer, can be effectively managed to allow it to contribute to the energy generation of the fuel cell system. After production in the integrated reformer, the reformate can pass through a first heat exchanger where its temperature can be adjusted to optimize conditions for the subsequent water gas shift reaction. This reaction, facilitated within the water gas shift reactor, can further refine the reformate by increasing its hydrogen content and reducing carbon monoxide levels. Post-reaction, the reformate can flow into a second heat exchanger where its temperature can be controlled to ensure it enters the fuel cell stack at an optimal temperature for efficient electricity generation. This precise temperature control of the reformate can serve to optimize and maintain the electrochemical efficiency within the fuel cell stack.

The fuel cell system can also include a coolant flow mechanism to maintain operational temperatures within acceptable limits, thereby protecting fuel cell system components and enhancing overall efficiency. The coolant can begin in the third heat exchanger, where it can be in thermal communication to transfer excess heat from the fuel cell components, including the fuel cell stack and the reformer. During the startup phase, a heater within the coolant flow loop can be activated to preheat the coolant, thereby facilitating a quicker rise to operational temperatures of the fuel cell stack. This preheating can allow for reduced startup times and enhance system responsiveness. Once heated, the coolant can circulate through the fuel cell stack, absorbing heat generated during the electrochemical reactions. The heated coolant can then return to the third heat exchanger, where its temperature can be reduced before recirculation. For example, a fan can facilitate removal of heat from the coolant as it passes through the third heat exchanger. This continuous flow of coolant can maintaining a stable thermal environment within the fuel cell system, ensuring consistent performance and militating against inefficiencies related to overheating.

### Application 1: Mobile Application in an Electric Vehicle

In a practical application of the fuel cell system, an electric vehicle (EV) can utilize the integrated HT-PEM fuel cell system for enhanced power generation. The vehicle can be equipped with a fuel cell stack that operates at temperatures between 120-200° C., using propane as the hydrocarbon fuel. The integrated reformer efficiently converts this fuel into a hydrogen-rich reformate, utilizing the cathode exhaust not only as an oxidant but also as a source of water vapor, which is crucial for the water gas shift reaction.

During operation, the fuel cell system's compressor supplies air to both the fuel cell stack and the reformer, ensuring optimal oxidation conditions and efficient fuel conversion. The fans associated with the heat exchangers actively manage the temperature of the reformate and the coolant loop, preventing overheating and maintaining system efficiency. This setup allows the vehicle to achieve greater fuel efficiency and reduced emissions compared to traditional combustion engines or conventional fuel cell systems.

Advantages of this fuel cell system in an EV is particularly notable during extended driving sessions where efficiency and reliability are paramount. The ability of the HT-PEM fuel cell to operate effectively at higher temperatures reduces the dependency on external cooling systems, which are typically a significant energy drain. Moreover, the compact nature of the fuel cell system, devoid of heavy condensers and vaporizers, contributes to a lighter vehicle with better energy consumption rates and enhanced performance.

### Application 2: Portable Power Generation for Remote Areas

In another example, the fuel cell system can be deployed as a portable power generator for remote or off-grid locations. The fuel cell system is designed to be lightweight and efficient, utilizing a small-scale HT-PEM fuel cell stack that operates with a minimal amount of hydrocarbon fuel, such as propane. The integrated reformer, utilizing cathode exhaust for oxidant and water vapor, significantly enhances the hydrogen production efficiency, making it ideal for scenarios where fuel economy is critical.

The operational control system of the generator is configured to manage startup and shutdown processes automatically, adjusting air and fuel flows to maintain optimal temperatures and reaction conditions. This automation ensures that the generator can be easily operated with minimal technical expertise, making it suitable for emergency situations or temporary setups in remote locations. The heat management facilitated by the strategically placed heat exchangers and fans ensures that the system remains stable and efficient under varying environmental conditions.

This portable generator provides a reliable and sustainable power source, capable of delivering electricity for lighting, communication, and medical equipment in areas without access to the grid. Its robust design and efficient operation underpin its utility in disaster relief operations, field research stations, and rural communities, highlighting the system's adaptability and practical benefits in diverse applications.

### Application 3: Stationary Backup Power Systems for Critical Infrastructure

The fuel cell system can also be implemented as a stationary backup power solution for critical infrastructure facilities, such as hospitals, data centers, and emergency response units. In this setup, the system uses natural gas as the hydrocarbon fuel, which is readily available in urban settings. The HT-PEM fuel cell stack, along with the integrated reformer, provides a high-efficiency power generation solution that can operate continuously or intermittently as required.

During power outages or periods of high demand, the system automatically activates, supplying essential power to maintain operations without interruption. The operational control system meticulously manages the fuel and air supply, ensuring that the fuel cell stack operates within safe temperature ranges and maintains optimal performance. The use of cathode exhaust in the reformer reduces the need for additional water supply for the gas shift reactions, simplifying the system's infrastructure and reducing operational costs.

The reliability and efficiency of this backup power system make it an invaluable asset for facilities requiring uninterrupted power to maintain critical operations. Its environmental benefits, coupled with lower operational costs compared to diesel generators, also support broader goals of sustainability and reduced carbon footprint for public and private sector facilities alike.

### Examples

Example embodiments of the present technology are provided with reference to the several figures enclosed herewith.

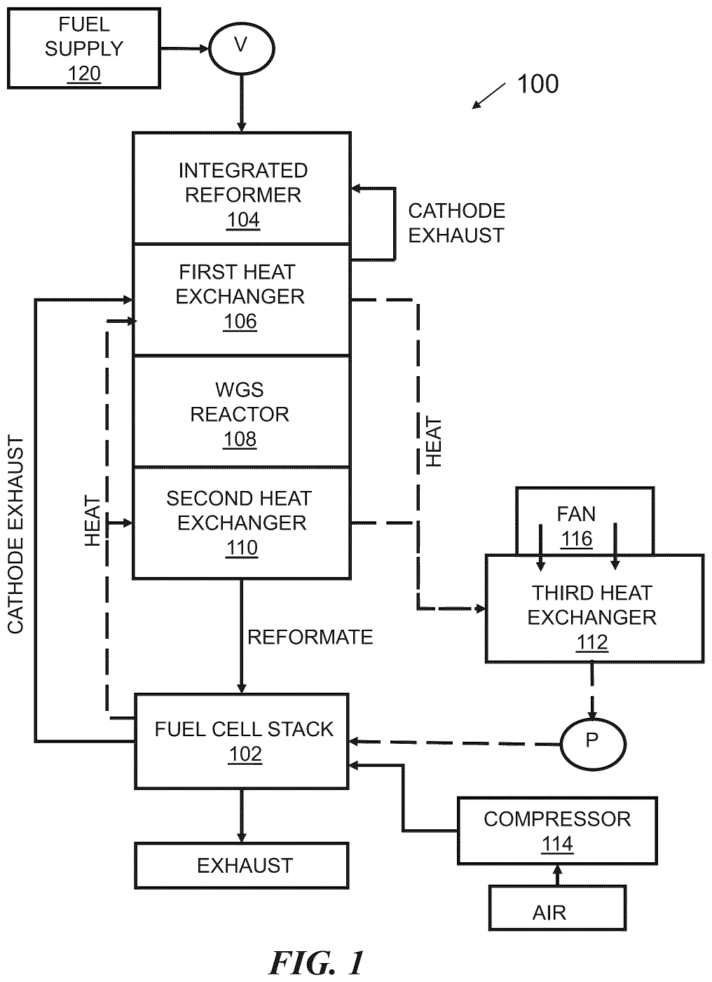

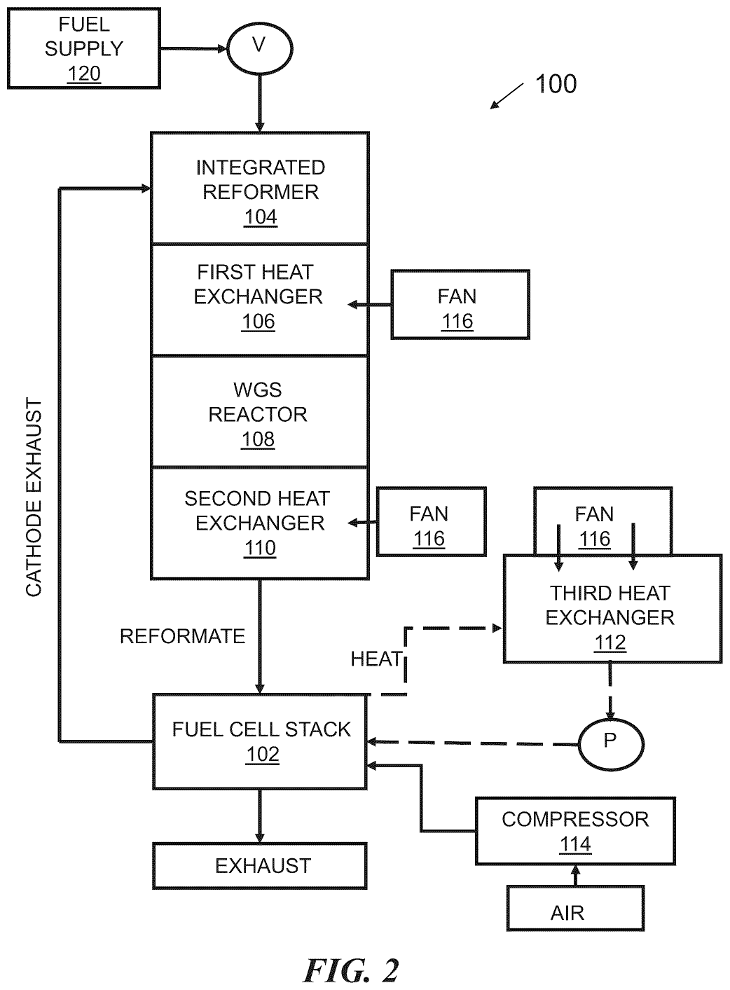

With reference to FIGS. 1-2, structural and operational aspects of a fuel cell system 100 constructed in accordance with the present technology are shown. FIG. 1 depicts the fuel cell system 100 operating in a first mode that includes preheating the cathode exhaust and utilizing a coolant for temperature control in the water gas shift reactor. FIG. 2 depicts the fuel cell system 100 in a second mode that bypasses the preheating of the cathode exhaust and employs direct air cooling for heat removal in the water gas shift reactor.

The fuel cell stack 102 provides for the electrochemical conversion of fuel to electricity and includes a high-temperature proton exchange membrane (HT-PEM) configured to operate effectively at temperatures between 120-200° C. An integrated reformer 104 is configured to receive cathode exhaust from the fuel cell stack, utilizing it to facilitate the reforming process where hydrocarbon fuels are converted into a hydrogen-rich gas. Adjacent to integrated reformer 104, a first heat exchanger 106 is positioned to heat reformate coming from the integrated reformer 104, enhancing the efficiency of the reforming process. A water gas shift reactor 108, in communication with the integrated reformer 104, can receive the reformate and converts carbon monoxide and water in the reformate into carbon dioxide and additional hydrogen, increasing the hydrogen yield. A second heat exchanger 110 is in thermal communication with the fuel cell stack 102 and controls the temperature of the reformate entering the fuel cell stack from the water gas shift reactor 108, ensuring it operates within the preferred temperature range.

A third heat exchanger 112 maintains the temperature of a coolant loop, managing the excess heat generated by the fuel cell stack. The third heat exchanger 112 can facilitate managing the excess heat generated by the fuel cell system, thereby militating against overheating and potential damage to the fuel cell system components. The third heat exchanger 112 can utilize a fixed flow rate cooling pump (P) to manage the cooling requirements effectively.

A compressor 114 supplies air to both the fuel cell stack 102 and the cathode exhaust to the integrated reformer, supporting the electrochemical and reforming reactions. Fans 116, associated with the heat exchangers 106, 110, 112, are used to control the temperature of the reformate and the coolant loop, preventing overheating. An operational control system manages the operation of the fuel cell system, including startup, steady-state operation, and shutdown, adjusting air and fuel flows to maintain optimal temperatures and reaction conditions. The fuel supply 120 provides hydrocarbon fuel, such as propane, to the integrated reformer. This delivery is controlled by a valve system (V), which regulates the flow of fuel based on the operational demands of the system, ensuring efficient and safe operation.

As shown in FIG. 1, in the first mode, cathode exhaust and heat can flow from the fuel cell stack 102 to the first heat exchanger 106. The first heat exchanger 106 can effectively preheat the cathode exhaust and the cathode exhaust can be sent to the integrated reformer 104. The integrated reformer 104 can react the hydrocarbon fuel from the fuel supply 120 and the cathode exhaust to form reformate. The reformate can flow through to the water gas shift reactor 108, which can further process the reformate to increase the amount of available hydrogen. The reformate can be heated by the second heat exchanger 110 before entering the fuel cell stack 102 to provide hydrogen fuel to the stack 102. In the first mode, the third heat exchanger 112 can remove heat from the first heat exchanger 106 and the second heat exchanger 110, as needed, if excess heat is generated throughout the fuel cell process. The third heat exchanger 112 can be in thermal communication with the fuel cell stack 102 and provide heat to the fuel cell stack 102, in operation.

As shown in FIG. 2, in the second mode, cathode exhaust can be directed to the integrated reformer 104, without exchanging heat with the first heat exchanger 106, where the cathode exhaust is provided along with the hydrocarbon fuel to the integrated reformer 104. The integrated reformer 104 can react the hydrocarbon fuel from the fuel supply 120 and the cathode exhaust to form reformate. The reformate can flow through to the water gas shift reactor 108, which can further process the reformate to increase the amount of available hydrogen. The reformate can be heated by the second heat exchanger 110 before entering the fuel cell stack 102 to provide hydrogen fuel to the stack 102. In the second mode, the third heat exchanger 112 is in a coolant loop with the fuel cell stack 102. The third heat exchanger 112 can remove heat from the fuel cell stack 102, where the pump (P) can cycle coolant through a coolant loop, in operation. Fans 116 can provide airflow to each of the first and second heat exchangers 106, 110 as needed.

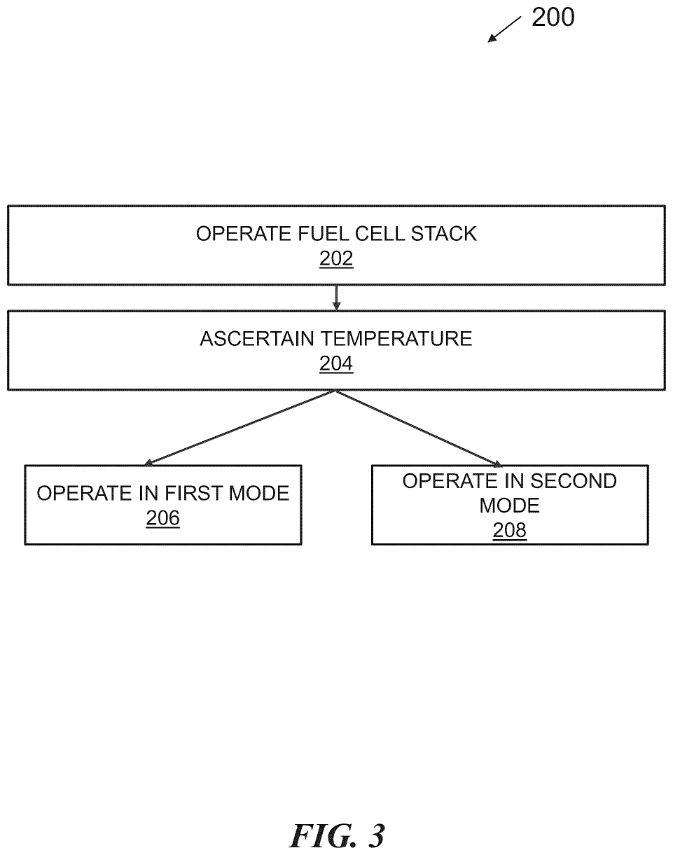

With reference to FIG. 3, a method 200 of operating the integrated fuel cell system 100 can involves several steps to allow for efficient and stable performance under varying conditions. Initially, the system 100, including the fuel cell stack 102, integrated reformer 104, and associated heat exchangers 106, 110, 112, can start up, in a step 202, by activating the compressor 114 to supply air to the fuel cell stack 102 and the integrated reformer 104. This air supply initiates the electrochemical reactions in the fuel cell stack 102 and the reforming reactions in the integrated reformer 104.

During step 204, the method 200 can include ascertaining the temperature. The temperature can be used to inform the mode of operation of the system 100.

The system can operate in two distinct modes based on external temperature conditions. In the first mode, the cathode exhaust is preheated using the first heat exchanger 106. This mode is particularly beneficial in colder external temperatures where maintaining a higher operational temperature is necessary for efficient reaction kinetics and optimal system performance. In the second mode, preheating of the cathode exhaust is bypassed, and direct air cooling is employed for heat removal in the water gas shift reactor. This mode is advantageous in warmer conditions, simplifying the system operation by reducing the complexity associated with heat management.

Accordingly, at step 206, the method 200 can include operating in the first mode when the temperature is below a predetermined temperature. A step 208 of the method can include operating in the second mode where the temperature is above the predetermined temperature. The method can include a step 210 a ascertain the temperature in order to determine which mode of operation should be used. This can be repeated throughout operation of the fuel cell system.

The present technology provides certain benefits and advantages by integrating a high-temperature proton exchange membrane (HT-PEM) fuel cell with an innovative reformer system that utilizes cathode exhaust for both oxidant and water vapor supply. This integration addresses the challenges of massive tanks for hydrogen storage and the need for low operating temperatures in conventional low-temperature proton electron membrane (LT-PEM) fuel cells. By operating at higher temperatures (120-200° C.) and eliminating the need for separate humidification, the HT-PEM fuel cell enhances membrane durability and facilitates heat removal. Furthermore, the use of cathode exhaust in the reformer significantly reduces the system's weight and complexity, eliminating the need for heavy condenser and vaporizer components, thus making the system more suitable for mobile applications and reducing overall costs. This inventive approach not only improves system efficiency but also overcomes the limitations of prior art by providing a more compact, efficient, and cost-effective solution.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A fuel cell system comprising:
a high temperature proton exchange membrane fuel cell stack;
an integrated reformer configured to selectively receive cathode exhaust from the fuel cell stack and fuel from a fuel supply, and produce reformate;
a first heat exchanger, in thermal communication with the integrated reformer, and configured to selectively control a temperature of one of the cathode exhaust from the fuel cell stack and the reformate from the integrated reformer;
a water gas shift reactor, in fluid communication with the integrated reformer, and configured to receive reformate therefrom and increase the amount of hydrogen in the reformate;
a second heat exchanger, in thermal communication with the water gas shift reactor, and configured to control a temperature of reformate entering the fuel cell stack from the water gas shift reactor; and
a third heat exchanger in communication with the fuel cell stack, the first heat exchanger, and the second heat exchanger and configured to maintain a temperature of the fuel cell stack;
wherein the fuel cell system is operable in a first mode and a second mode,
the first mode operating the first heat exchanger with preheated cathode exhaust, and
the second mode without cathode exhaust preheating and with heat removal directly to ambient air for water gas shift reactor temperature control, the second mode including bypassing the preheating of the cathode exhaust and utilizing air cooling for heat removal in the water gas shift temperature reactor temperature control.

2. The system of claim 1, wherein the integrated reformer includes a reactor operating under conditions selected from the group consisting of catalytic partial oxidation (cPOx), autothermal reforming (ATR), and water gas shift (WGS).

3. The system of claim 1, further comprising a compressor configured to supply air to the fuel cell stack.

4. The system of claim 3, wherein the compressor supplies the cathode exhaust to the first heat exchanger in the first mode.

5. The system of claim 3, wherein the compressor is configured to transfer cathode exhaust to the integrated reformer in the second mode.

6. The system of claim 1, wherein the coolant loop includes a pump configured to circulate a coolant to regulate a temperature of the fuel cell stack.

7. The system of claim 1, wherein the fuel supply is configured to provide hydrocarbon fuel to the integrated reformer.

8. The system of claim 7, further comprising a valve system configured to control the fuel supply to the integrated reformer.

9. The system of claim 7, wherein the hydrocarbon fuel includes propane.

10. The system of claim 1, further comprising an operational control system configured to manage the operation of the fuel cell system, including startup, steady-state operation, and shutdown.

11. The fuel cell system of claim 1, wherein the first heat exchanger is operable to utilize a coolant flow to control the temperature of the cathode exhaust during the first mode of operation.

12. The fuel cell system of claim 1, wherein the second heat exchanger is configured to utilize a fan system to maintain the temperature of reformate entering the fuel cell stack.

13. The fuel cell system of claim 1, wherein the third heat exchanger is configured to utilize a fixed flow rate cooling pump.

14. The fuel cell system of claim 1, wherein the fuel cell system is configured to switch between the first mode and the second mode based on an external temperature condition, utilizing air cooling for heat removal directly to ambient air in the second mode.

15. The fuel cell system of claim 1, wherein the fuel cell stack is in thermal communication with the first heat exchanger and the second heat exchanger in the first mode.

16. The fuel cell system of claim 1, wherein the integrated reformer includes a heating element configured to heat the hydrocarbon fuel and the cathode gas.

17. The fuel cell system of claim 1, wherein the third heat exchanger is in thermal communication with the first heat exchanger and the second heat exchanger in the first mode.

18. A method of operating a fuel cell system comprising:
providing the fuel cell system including:
a high temperature proton exchange membrane fuel cell stack;
an integrated reformer configured to selectively receive cathode exhaust from the fuel cell stack and fuel from a fuel supply, and produce reformate;
a first heat exchanger, in thermal communication with the integrated reformer, and configured to selectively heat one of the cathode exhaust from the fuel cell stack and the reformate from the integrated reformer;
a water gas shift reactor, in fluid communication with the integrated reformer, and configured to receive reformate therefrom and increase the amount of hydrogen in the reformate;
a second heat exchanger, in thermal communication with the water gas shift reactor, and configured to control a temperature of reformate entering the fuel cell stack from the water gas shift reactor; and
a third heat exchanger in communication with the fuel cell stack, the first heat exchanger, and the second heat exchanger and configured to maintain a temperature of the fuel cell stack; and
selectively operating the system:
a first mode the first mode operating the first heat exchanger with preheated cathode exhaust, or
a second mode wherein preheating of the cathode exhaust is bypassed and air cooling is utilized for heat removal in the water gas shift temperature reactor temperature control, the second mode without cathode exhaust preheating and with heat removal directly to ambient air for water gas shift reactor temperature control, the second mode including bypassing the preheating of the cathode exhaust and utilizing air cooling for heat removal in the water gas shift temperature reactor temperature control.

19. The method of claim 18, wherein the first mode is selected when an external temperature is below a predetermined threshold.

20. The method of claim 18, wherein the second mode is selected when an external temperature is above a predetermined threshold.
